(19) United States
(12) Patent Application Publication
(10) Pub. No.: US 2009/0073296 A1
(43) Pub. Date: Mar. 19, 2009

(54) Imaging device and imaging apparatus

(76) Inventor: Masaaki Koshiba, Kurokawa-gun (JP)

Correspondence Address: BIRCH STEWART KOLASCH & BIRCH, PO BOX 747, FALLS CHURCH, VA, 22040-0747, US

(21) Appl. No.: 12/230,612

(22) Filed: Sep. 2, 2008

(30) Foreign Application Priority Data
Sep. 11, 2007 (JP) P2007-235474

(51) Int. Cl. H04N 3/14

(52) U.S. Cl. 348/302

(57) ABSTRACT

An imaging device includes: a plurality of photoelectric conversion elements; a plurality of vertical electric charge transfer paths; a horizontal transfer path that transfers; and a plurality of transfer connecting parts, wherein each of the transfer connecting parts includes an electric charge transfer channel that transfers a signal electric charges in a column direction, a width of the electric charge transfer channel in a row direction continuously increases over an entire part or a part of the electric charge transfer channel, a downstream side of the electric charge transfer channel in the column direction is large in increasing rate of the channel width than an upstream side of the electric charge transfer channel in the column direction.

### BACKGROUND OF THE INVENTION

1. Field of the Invention

The present invention relates to an imaging device that generates a signal electric charge in accordance with an incident light and transfers the signal electric charge to an output part and an imaging apparatus having the imaging device.

2. Background Art

Usually, in an imaging apparatus such as a digital camera, an imaging device is used as an image sensor for generating a signal electric charge in accordance with an incident light and outputting the signal electric charge to generate image data. As the imaging device, there is a solid state imaging device including a plurality of photoelectric conversion elements arranged in the directions of rows and the directions of columns in an imaging area to receive the incident lights respectively by the photoelectric conversion elements to generate the signal charges, vertical electric charge transfer passages (VCCD) for transferring the signal electric charges read from the photoelectric conversion elements in the directions of the columns and a horizontal electric charge transfer passage (HCCD) for transferring the signal electric charges transferred respectively from the downstream sides of the transfer directions of the VCCDs in the direction of a row.

As the imaging apparatus having the solid state imaging device, an imaging apparatus is developed that has a still image recording mode and a moving image recording mode. In such an imaging apparatus, the number of pixels of a still image is large as high as 4000000 to 6000000 pixels, however, the number of pixels during picking up a moving image is decreased in order to realize a high-speed process. Therefore, in the moving image recording mode, the signal electric charges are partly added (a vertical addition) in the VCCDs. Further, after the signal electric charges are transferred to the HCCD from the VCCDs, the signal electric charges are added (a horizontal addition) in the HCCD so that the image data in which the pixels are substantially thinned is generated.

In the solid state imaging device, to realize the horizontal addition, line memories are provided at the joint parts of the VCCDs and the HCCD in the downstream sides of the transfer directions of the VCCDs. Since the line memories temporarily store the signal electric charges vertically transferred by the VCCDs of prescribed rows and then transfer the signal electric charges to the HCCD, the signal electric charges can be added in the HCCD. Usually, the solid state imaging device provided with the line memories is disclosed in, for instance, JP-A-2002-185870 (the term “JP-A” as used herein means an “unexamined published Japanese patent application”) and JP-A-7-161970.

In recent years, as the number of pixels is more increased and a density is higher in a solid state imaging device, the micronization of the imaging device progresses, so that the channel width of an electric charge transfer channel of a line memory is narrowed. Thus, the transfer efficiency of a signal electric charge from the line memory to an HCCD is liable to be lowered. Then, the signal electric charge cannot be properly transferred from a VCCD to the HCCD. Accordingly, there is a possibility that an inconvenience arises (what is called an improper longitudinal line) in which a longitudinal line extending in the direction of a row is displayed in a picked-up image.

Especially, as in the imaging device disclosed in the Patent Document 1, in the structure that the line memories are provided at the joint parts of the VCCDs and the HCCD, the imaging device is formed so that the channel width of the electric charge transfer channel of the line memory is continuously expanded in the transfer direction. However, not only the transfer efficiency of the signal electric charge and an amount of saturation of the electric charge establish a relation of a trade-off, but also the gradient of a potential is loose in the downstream side of the transfer direction of the electric charge transfer channel. Thus, there is a room for improvement in view of the generation of an imperfect transfer.

### SUMMARY OF THE INVENTION

The present invention is devised by considering the above-described circumstances, and it is an object of the present invention to provide an imaging device and an imaging apparatus that can prevent the transfer efficiency of a signal electric charge from a vertical electric charge transfer passage to a horizontal electric charge transfer passage from being deteriorated.

(1) According to a first aspect of the present invention, An imaging device includes: a plurality of photoelectric conversion elements that are arranged in a row direction and a column direction of an imaging area, and that generate signal electric charges in accordance with incident light; a plurality of vertical electric charge transfer paths that transfer the signal electric charges generated in the photoelectric conversion elements in the column directions; a horizontal transfer path that transfers, in the row direction, the signal electric charges transferred from downstream sides of the vertical electric charge transfer paths in the column direction; and a plurality of transfer connecting parts that are formed at downstream side end portions of the vertical electric charge transfer paths, wherein each of the transfer connecting parts includes an electric charge transfer channel that transfers the signal electric charges in the column direction, a width of the electric charge transfer channel in the row direction continuously increases over an entire part or a part of the electric charge transfer channel, a downstream side of the electric charge transfer channel in the column direction is large in increasing rate of the channel width than an upstream side of the electric charge transfer channel in the column direction.
(2) The imaging device as described in the item (1), wherein each of the electric charge transfer channels includes: a first channel expanding part; and a second channel expanding part, a channel width of each of the first channel expanding part and a channel width of the corresponding second channel expanding part increasing continuously in the column direction, each of the first channel expanding part is formed on the upstream side of the corresponding second channel expanding part in the column direction, and each of the second channel expanding part is larger in the increasing rate of the channel width than the corresponding first channel expanding part.
(3) The imaging device as described in the item (2), wherein each of the electric charge transfer channels comprises a part having a constant channel width in the row direction between the first channel expanding part and the second channel expanding part.
(4) The imaging device as described in any one of the items (1) to (3), wherein the transfer connecting parts are line memories.
(5) The imaging device as described in any one the items (1) to (3), wherein the transfer connecting part constitutes a final transfer stage of transfer stages, arranged in the row direction, of each vertical electric charge transfer path.
(6) The imaging device as described in the items (1) to (5), wherein the electric charge transfer channels are N type impurity diffusion areas.
(7) According to a second aspect of the present invention, an imaging apparatus including the imaging device according to any one of the items (1) to (6).

The imaging device of the present invention has the structure that the signal electric charges generated in the photoelectric conversion elements during a driving operation are transferred by the vertical electric charge transfer paths and the horizontal electric charge transfer part. The signal electric charges are transferred to the horizontal transfer part from the downstream sides of the transfer directions of the vertical electric charge transfer paths through the transfer connecting parts. Since each of the transfer connecting parts has a part in which the channel width is continuously increased in the transfer direction, the transfer connecting part is formed so that the depth of a potential is lower relative to the transfer direction. Here, the electric charge transfer channel is formed so that the degree of expansion of the channel width in the downstream side of the transfer direction is larger than that in the upstream side of the transfer direction. Thus, a phenomenon can be prevented that the gradient of the potential is loose in the downstream side of the transfer direction as in the usual structure that the channel width is increased at a prescribed rate toward the transfer direction. In such a way, in the present invention, the degree of expansion of the channel width is larger in a downstream area in which the gradient of the potential of the electric charge transfer channel is apt to be loose than that in an upstream area, so that the inclination of the gradient of the potential can be ensured and the transfer efficiency of the signal electric charge can be prevented from being deteriorated.

According to the present invention, then imaging device and the imaging apparatus can be provided that can prevent the transfer efficiency of the signal electric charge from the vertical electric charge transfer passage to the horizontal electric charge transfer passage from being deteriorated.

### BRIEF DESCRIPTION OF THE DRAWINGS

The invention disclosed herein will be understood better with reference to the following drawings of which:

FIG. 1 is a diagram for explaining the structure of an imaging device;

FIG. 2 is a diagram for explaining the structure of a first embodiment;

FIG. 3 is a diagram for explaining the structure of a second embodiment;

FIG. 4 is a diagram for explaining the structure of a usual imaging device; and

FIG. 5 is a graph for comparing between the gradient of a potential of an imaging device shown in FIG. 2, the gradient of a potential of an imaging device shown in FIG. 3 and the gradient of the potential of the usual imaging device shown in FIG. 4.

### DETAILED DESCRIPTION OF THE INVENTION

Now, embodiments of the present invention will be described in detail by referring to the drawings.

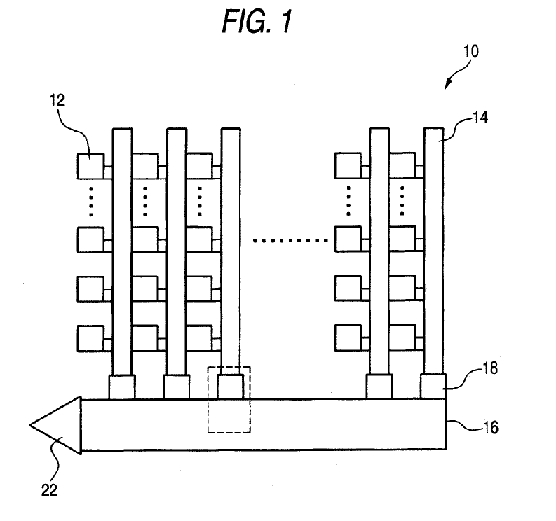

FIG. 1 is a diagram showing the structure of an imaging device according to the present invention. In a solid state imaging device 10, an imaging area is divided on a semiconductor substrate of silicon or the like. A plurality of photoelectric conversion elements 12 are arranged in the form of a matrix in the directions of columns (vertical directions in FIG. 1) of the imaging area and in the directions of rows (horizontal directions in FIG. 1). The photoelectric conversion elements 12 serve to photo-electrically convert incident lights and generate signal electric charges corresponding to the incident lights and are formed with, for instance, photodiodes or the like.

Between the columns of the photoelectric conversion elements 12, vertical electric charge transfer paths 14 extending in the directions of the columns are respectively provided. The vertical electric charge transfer paths 14 include a plurality of electric charge transfer electrodes arranged in the directions of the columns. Vertical driving signals are respectively inputted to the electric charge transfer electrodes. Each of the plurality of electric charge transfer electrodes and an n type channel formed on the surface side of the semiconductor substrate correspondingly to each electric charge transfer electrode form a transfer stage. When a prescribed vertical driving signal is inputted to each transfer stage, a signal electric charge is transferred along the direction of the column. To a final transfer stage located at an end in the transfer direction of each vertical electric charge transfer path 14, a line memory 18 is connected. The line memories 18 are respectively connected to a horizontal electric charge transfer path 16. The horizontal electric charge transfer path 16 transfers the signal electric charges transferred from the line memories 18 to the direction of a row (a leftward direction in FIG. 1) and outputs the signal electric charges from an output amplifier 22.

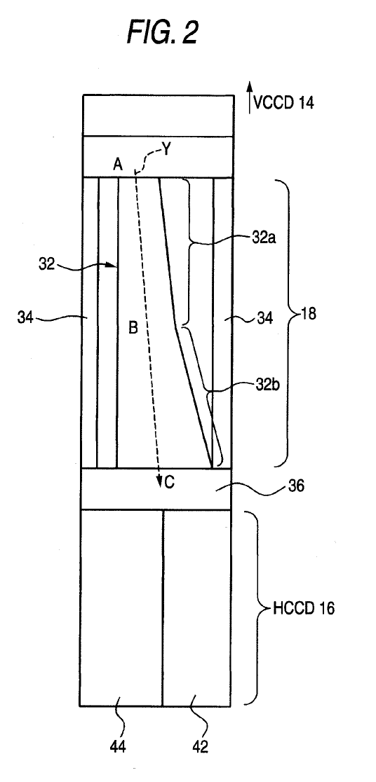

FIG. 2 concerns a first embodiment of the imaging device and is an enlarged view for explaining the structure of a part surrounded by a broken line in FIG. 1. As shown in FIG. 2, the horizontal electric charge transfer path 16 has one horizontal electric charge transfer channel extending in the form of a belt in the direction of the row of the arrangement of the photoelectric conversion elements 12. On this horizontal electric charge transfer channel, a first horizontal electric charge transfer electrode 42 and a second electric charge transfer electrode 44 are alternately formed in the direction of the row. The first horizontal electric charge transfer electrode 42 and the second horizontal electric charge transfer electrode 44 are formed with poly-silicon on the semiconductor substrate on which the imaging device 10 is formed through an insulating film. In this embodiment, one pair including the first horizontal electric charge transfer electrode 42 and the second horizontal electric charge transfer electrode 44 is formed to serve as one transfer stage relative to one vertical electric charge transfer path 14 during a horizontal transfer.

When the horizontal electric charge transfer path 16 is driven by two phase horizontal driving signals φ H1 and φH2, the first horizontal electric charge transfer electrode 42 and the second horizontal electric charge transfer electrode 44 corresponding to the same vertical electric charge transfer path 14 are connected to a common signal wiring as the one transfer stage and the horizontal driving signals φH1 and φH2 different from those of adjacent transfer stages are inputted from a driving circuit not shown in the drawing.

The line memory 18 includes an electric charge transfer channel 32 for transferring the signal electric charge transferred from the vertical electric charge transfer path 14 to the horizontal electric charge transfer path 16 and electric charge separating areas 34 for ensuring an electric insulation from the adjacent line memories 18. In this embodiment, the electric charge transfer channel 32 is an N type impurity diffusion area formed by implanting ions of N type impurities in the semiconductor substrate of the imaging device 10.

The electric charge transfer channel 32 includes a first channel expanding part 32a and a second channel expanding part 32b formed so that a channel width is continuously increased toward the transfer direction. In this embodiment, the first channel expanding part 32a is formed in the upstream side of the transfer direction of the electric charge transfer channel 32 and the second channel expanding part 32b is formed in the downstream side of the transfer direction. A degree of expansion of the channel width of the second channel expanding part 32b is larger than that of the channel width of the first channel expanding part 32a.

Between an end part of the electric charge transfer channel 32 in the transfer direction and the horizontal electric charge transfer path 16, a barrier area 36 is formed that functions as a barrier of the signal electric charge. The barrier area 36 is formed by implanting ions of impurities.

The electric charge transfer channel 32 has one end edge (a left side edge in FIG. 2) in the direction of a row that is formed by a straight line substantially parallel to the direction of a column and the other end edge (a right side edge in FIG. 2) that is inclined so as to be separated from the one end edge toward the transfer direction. However, the form of the electric charge transfer channel 32 is not especially limited. As long as the electric charge transfer channel 32 is formed so that the degree of expansion of the channel width in the downstream side of the transfer direction of the electric charge transfer channel 32 is larger than that of the upstream side of the transfer direction, the electric charge transfer channel 32 may be modified.

Further, in this embodiment, the electric charge transfer channel 32 of the line memory 18 is used as a transfer connecting part to transfer the signal electric charge between the vertical electric charge transfer path 14 and the horizontal electric charge transfer path 16. However, the final transfer stage of transfer stages arranged in the transfer direction of the vertical electric charge transfer path 14 may be used as the transfer connecting part.

In the imaging device 10 of this embodiment, the electric charge transfer channel 32 of the line memory 18 is formed so that the degree of expansion of the channel width in the downstream side of the transfer direction is larger than that of the upstream side of the transfer direction. Thus, a phenomenon can be prevented that the gradient of a potential is loose in the downstream side of the transfer direction as in the usual structure that the channel width is increased at a prescribed rate toward the transfer direction. Therefore, according to the present invention, the degree of expansion of the channel width is made to be larger in a downstream area in which the gradient of the potential of the electric charge transfer channel 32 is apt to be loose than that in an upstream area, so that the inclination of the gradient of the potential can be ensured and the transfer efficiency of the signal electric charge can be prevented from being deteriorated.

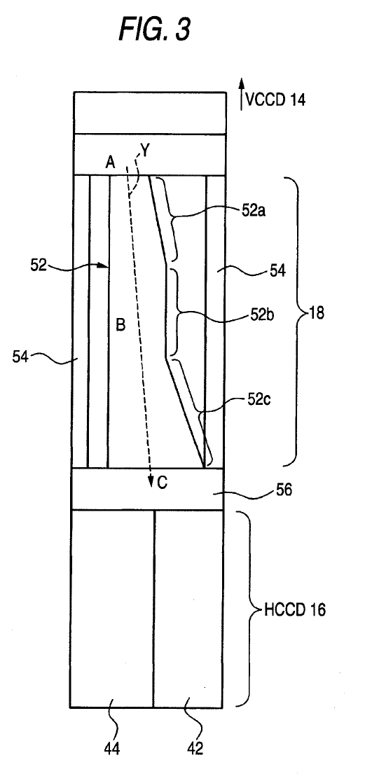

FIG. 3 is a diagram for explaining a second embodiment of an imaging device according to the present invention. In the imaging device of this embodiment, other parts or functions thereof than the form of the electric charge transfer area of the imaging device 10 of the first embodiment shown in FIG. 2 are the same as those shown in FIG. 2. Accordingly, members having the same structures and operations as those of the already described members are designated by the same or corresponding reference numerals in the drawing and an explanation of them is simplified or omitted.

As shown in FIG. 3, in this embodiment, an electric charge transfer channel 52 includes a first channel expanding part 52a and a second channel expanding part 52c formed so that a channel width is continuously increased toward a transfer direction. Between the first channel expanding part 52a and the second channel expanding part 52c, an area 52b is formed that has an equal channel width toward the transfer direction. The first channel expanding part 52a is formed in the upstream side of the transfer direction of the electric charge transfer channel 52 and the second channel expanding part 52c is formed in the downstream side of the transfer direction. A degree of expansion of the channel width of the second channel expanding part 52c is made to be larger than that of the channel width of the first channel expanding part 52a. Specifically, the electric charge transfer channel 52 has one end edge (a left side edge in FIG. 3) in the direction of a row that is formed by a straight line substantially parallel to the direction of a column and the other end edges (right side edges in FIG. 3) respectively in the first channel expanding part 52a and the second channel expanding part 52c that are inclined so as to be separated from the one end edge toward the transfer direction. In FIG. 3, reference numeral 54 designates an electric charge separating area and 56 designates a barrier area.

In this embodiment, the upstream side in which the gradient of a potential is not loose is daringly made to be shallow. The channel width in the central part of the transfer direction of the electric charge transfer channel is constantly extended. The degree of expansion of the channel width is made to be larger in the downstream side in which the gradient of the potential is apt to be loose than that in the upstream area. In other words, the central part of the transfer direction of the electric charge transfer channel has an area having the constant channel width to ensure a distance for increasing the channel width in the downstream side.

According to the structure of this embodiment, the electric charge transfer channel 52 of a line memory 18 is formed so that the degree of expansion of the channel width is made to be larger in the downstream side that in the upstream side. Thus, the gradient of the potential can be prevented to being loose in the downstream side of the transfer direction. According to the present invention, the transfer efficiency of a signal electric charge can be prevented from being deteriorated.

Now, in the structure of the imaging device of this embodiment, the imaging device of this embodiment will be compared with a usual imaging device in view of the structure and the gradient of the potential.

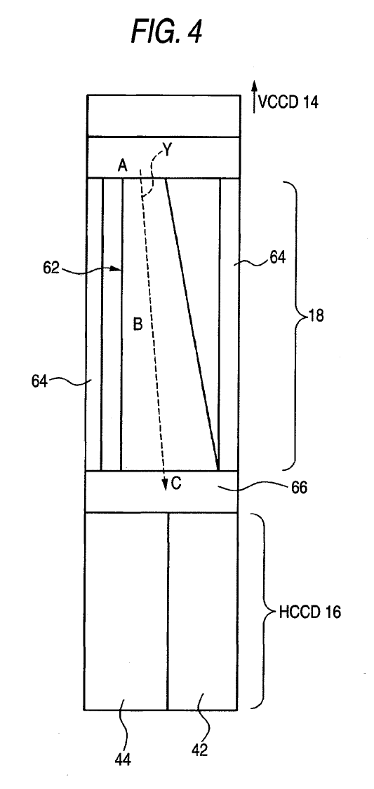

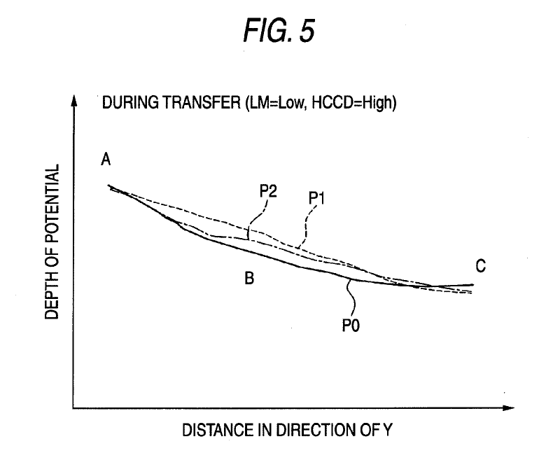

FIG. 4 is a diagram for explaining the structure of the usual imaging device. FIG. 5 is a graph for comparing between the gradient of the potential of the imaging device shown in FIG. 2, the gradient of the potential of the imaging device shown in FIG. 3 and the gradient of the potential of the usual imaging device shown in FIG. 4. In FIG. 5, the depth of the potential is shown relative to a distance in the direction of an arrow mark Y respectively shown in FIGS. 2 to 4. Further, positions A, B and C are set that are common to the distance in the direction of the arrow mark Y in the electric charge transfer channels of the imaging devices shown in FIGS. 2 to 4. The position B is set to a substantially central part of the positions A and C.

As shown in FIG. 4, the usual imaging device is formed so that the channel width of an electric charge transfer channel 62 of a line memory 18 is continuously increased toward a transfer direction. In this case, a degree of expansion of the channel width is constant in the transfer direction. In FIG. 4, reference numeral 64 designates an electric charge separating area and 66 designates a barrier area.

As shown in FIG. 5, in the potential P1 of the imaging device shown in FIG. 2 and the potential P2 of the imaging device shown in FIG. 3, the gradient of the potential between the positions A and B in the electric charge transfer channels 32 and 52 is substantially the same as the gradient of the potential between the positions B and C. However, in the potential P0 of the imaging device shown in FIG. 4, the gradient of the potential between the positions B and C is in a horizontal state. Further, in the vicinity of the position C, a phenomenon is recognized that the direction of the gradient is reversed. This phenomenon arises owing to an influence that ions are implanted to form the barrier area connected to an end part of the downstream side of the electric charge transfer channel. On the other hand, since the imaging devices shown in FIGS. 2 and 3 are respectively formed so that the degree of the expansion of the channel width is made to be larger in the downstream side of the transfer direction of the electric charge transfer channel than that in the upstream side of the transfer direction, the influence of doping ions of the barrier area is suppressed in the position C. Thus, the gradient of the potential of the electric charge transfer channel can be ensured. As described, in the imaging devices shown in FIGS. 2 and 3, during the driving operation, the transfer efficiency of the signal electric charge can be prevented from being deteriorated in the transfer connecting part between the vertical electric charge transfer path and the horizontal electric charge transfer part.

Further, when the imaging device of the above-described embodiments is employed as an image sensor of an imaging apparatus such as a digital camera, since the transfer efficiency can be prevented from being deteriorated during an image pickup operation, the generation of an inconvenience such as an improper longitudinal line can be prevented.

The present application claims foreign priority based on Japanese Patent Application (JP 2007-235474) filed Sep. 11 of 2007, the contents of which is incorporated herein by reference.

What is claimed is:

1. An imaging device comprising:
a plurality of photoelectric conversion elements that are arranged in a row direction and a column direction of an imaging area, and that generate signal electric charges in accordance with incident light;
a plurality of vertical electric charge transfer paths that transfer the signal electric charges generated in the photoelectric conversion elements in the column directions;
a horizontal transfer path that transfers, in the row direction, the signal electric charges transferred from downstream sides of the vertical electric charge transfer paths in the column direction; and
a plurality of transfer connecting parts that are formed at downstream side end portions of the vertical electric charge transfer paths,
wherein
each of the transfer connecting parts includes an electric charge transfer channel that transfers the signal electric charges in the column direction,
a width of the electric charge transfer channel in the row direction continuously increases over an entire part or a part of the electric charge transfer channel,
a downstream side of the electric charge transfer channel in the column direction is large in increasing rate of the channel width than an upstream side of the electric charge transfer channel in the column direction.

2. The imaging device as claimed in claim 1,
wherein
each of the electric charge transfer channels comprises:
a first channel expanding part; and
a second channel expanding part,
a channel width of each of the first channel expanding part and a channel width of the corresponding second channel expanding part increasing continuously in the column direction,
each of the first channel expanding part is formed on the upstream side of the corresponding second channel expanding part in the column direction, and
each of the second channel expanding part is larger in the increasing rate of the channel width than the corresponding first channel expanding part.

3. The imaging device as claimed in claim 2,
wherein
each of the electric charge transfer channels comprises a part having a constant channel width in the row direction between the first channel expanding part and the second channel expanding part.

4. The imaging device as claimed in claim 1,
wherein
the transfer connecting parts are line memories.

5. The imaging device as claimed in claim 1,
wherein
the transfer connecting part constitutes a final transfer stage of transfer stages, arranged in the row direction, of each vertical electric charge transfer path.

6. The imaging device as claimed in claim 1,
wherein
the electric charge transfer channels are N type impurity diffusion areas.

7. An imaging apparatus comprising the imaging device according to claim 1.
